(19) United States
(12) Patent Application Publication
(10) Pub. No.: US 2011/0056894 A1
(43) Pub. Date: Mar. 10, 2011

(54) METHOD AND SYSTEM FOR FILTERING WATER, IN PARTICULAR, AN ULTRAFILTRATION METHOD

(75) Inventor: DIRK SCHEU, Amerdingen (DE)

(73) Assignee: KRONES AG, Neutraubling (DE)

(21) Appl. No.: 12/872,052

(22) Filed: Aug. 31, 2010

(30) Foreign Application Priority Data
Sep. 4, 2009 (DE) 102009040142.3

(51) Int. Cl. B01D 65/02; B01D 29/68; B01D 61/20

(52) U.S. Cl. 210/790; 210/321.69

(57) ABSTRACT

A water-filtering method has effectiveness and reduced contamination, and is in particular an ultrafiltration method, and a filtration system contains a plurality of individual filtration modules, each of which is supplied with untreated water via at least one untreated water inlet, and whose filtrate is removed via a filtrate outlet. The filtration modules are backwashed with filtrate, and are divided into groups, wherein during backwashing, each group is individually separated from the untreated water inflow and rinsed with the filtrate that is produced by the remaining groups and fed back during the backwashing.

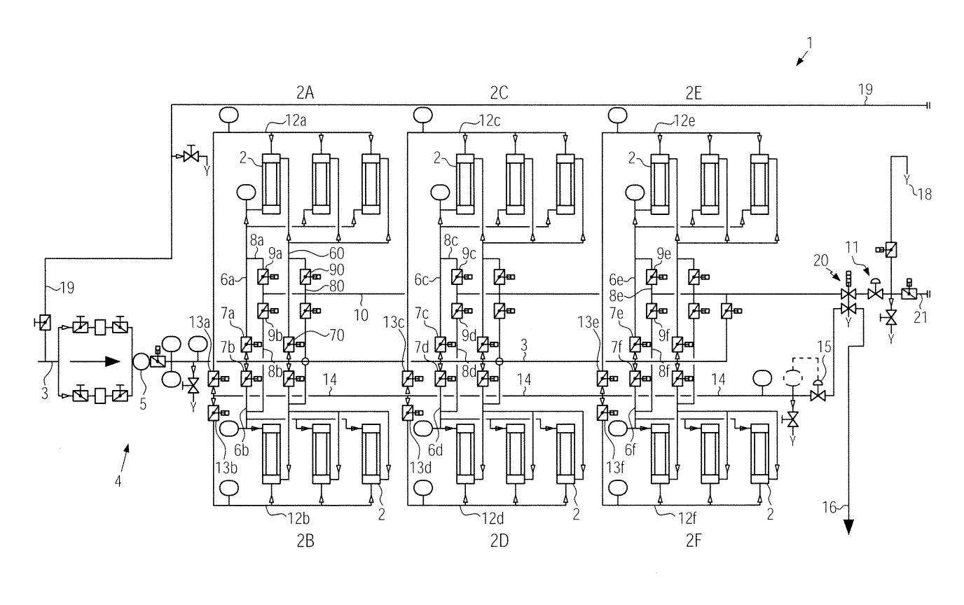

### CROSS-REFERENCE TO RELATED APPLICATION

The present application claims the benefit of priority of German Application No. 102009040142.3, filed Sep. 4, 2009. The entire text of the priority application is incorporated herein by reference in its entirety.

### FIELD OF THE DISCLOSURE

The disclosure relates to a method for filtering water, in particular, an ultrafiltration method, and a filter system.

### BACKGROUND

Ultrafiltration systems are currently built in various forms, but the method frequently proceeds in a similar manner, i.e., the filtrate created (free of germs, bacteria and viruses as far as possible) is caught in a batch tank/temporary container and pumped from there to the consumer. The water needed for the backwashing and CIP (cleaning-in-place) of the ultrafiltration modules is also taken from there. This operating method holds the danger that, on the one hand, undissolved constituents can reach the filtrate side of the ultrafiltration via the chemicals used during the CIP process. On the other hand, during this process of backwashing, microbiological impurities can, via the filtrate, reach the filtrate side from the filtrate tank itself. The removal of these contaminations is problematic, especially in the case of the so-called in-out method for hollow-fiber filtration modules (filtration operation from the inside outwards). A further disadvantage is that during the backwashing, no filtrate can be produced because the same line is used.

EP 899 238 describes a multi-stage filtration system in which the second stage can be backwashed with the permeate generated in the first stage. However, this method functions only in those places in which various stages are provided which are run through one after the other. It is also not possible to rinse the first stage with permeate that has not first been stored in a tank.

### SUMMARY OF THE DISCLOSURE

One aspect of the disclosure is providing an effectively working filtering method for treating water and a filter system suitable for this purpose.

The development according to the disclosure makes it possible to rinse individual filtration modules while the production process continues running, so that it is not necessary to shut down the entire system. The backwashing furthermore takes place by means of filtrate from the ongoing production process, so that there is no contamination or microbial growth during an unavoidable storage time.

The throughput performance of the other groups is preferably increased while one group is being rinsed, so that the amount of permeate leaving the system remains constant even during the rinsing.

The quantity of filtrate generated is preferably regulated downstream of all groups jointly for all groups.

The quantity of backwash fluid is also regulated.

Especially advantageous is the fact that the disclosure allows CLP from the untreated water side. In this way, in turn, each group can undergo CIP separately, and contamination of the discharging filtrate by chemicals is excluded.

The redirection of the filtrate into the group of filtration modules to be rinsed is preferably achieved by means of a regulating valve in the filtrate line.

This adjustment of the quantity is supported by a regulating valve provided in the wastewater disposal line.

To increase the quantity of filtrate while one group is being rinsed, a controllable intake pump is preferably provided.

### BRIEF DESCRIPTION OF THE DRAWING

An embodiment of the disclosure is explained in more detail in the following using the sole drawing, which shows a schematic circuit diagram of a filtration system according to the disclosure.

### DETAILED DESCRIPTION OF THE PREFERRED EMBODIMENT

The filtration system 1 shown is an ultrafiltration system and it includes a multiplicity of filtration modules 2, each of which contains a bundle of hollow fibers, through the walls of which the filtration takes place. The filtration modules 2 are essentially identical throughout the entire system and fulfil the same function. The filtration modules 2 are combined into groups 2A, 2B, 2C, 2D, 2E and 2F. Each of the groups 2A to 2F preferably contains the same number of modules 2, whereby three modules are provided for each of the groups 2A to 2F in the embodiment shown. The number can, however, be varied as needed, and in an extreme case, each group can also contain only one module.

Untreated water is fed to the filtration modules 2 via a line 3. The untreated water first flows through the customary pre-filter/pump complex 4, which contains a customary pre-filter and a controllable intake pump 5. From this untreated water line 3, an untreated water branch line 6 branches off in the area of each of the respective groups, whereby the branch line 6a is assigned to group 2A, 6b to the group 2B, 6c to the group 2C, 6d to the group 2D, 6e to the group 2E and 6f to the group 2F. Each of these branch lines 6 can be shut off with a shut-off device 7, whereby the shut-off devices 7a, 7b, 7c, 7d, 7e and 7f are assigned to that group 2A to 2F with the matching letter.

The branch lines 6 supply, via the corresponding sub-branch connections, each module of each group directly with the untreated water fed into the system. In the embodiment shown, all branch lines lead into the lower area of the hollow fiber bundles that stand upright.

A sub-branch connection of a wastewater disposal line 8 leads out of the lower area of each of the modules 2, whereby this wastewater disposal line 8 is, in turn, connected to all modules of a group and, in the embodiment shown, is initially identical to the untreated water branch connection 6. Again, the wastewater disposal lines 8 assigned to the corresponding groups are identified with the same letters as those for the assigned groups. Each of the wastewater disposal lines 8 leads into a wastewater disposal line 10 via corresponding shut-off devices 9. In the embodiment shown, the wastewater disposal line 10 is common to all groups 2A to 2F and is provided with a regulating valve 11 downstream of the last group, whereby the outward flow quantity through the wastewater disposal line 10 can be adjusted by means of the regulating valve 11.

A filtrate line 12 leads out of each of the modules 2 of each group 2A to 2F, again via sub-branch connections, whereby the filtrate lines of each group again bear the corresponding letters. Each filtrate line 12a to 12f is connected in each case to a filtrate collection line 14 via a shut-off device 13, whereby the filtrate collection line 14 is provided with a regulating valve 15 downstream of the last group 2F. The amount of filtrate discharged can be adjusted by means of this regulating valve. Where necessary, a shut-off device can be provided downstream of both the wastewater regulating valve 11 and the filtrate regulating valve 15, for example, in a discharge line 16 to the consumer.

If all groups 2A to 2F are in filter operation, untreated water is supplied to each module 2 of each group 2A to 2F via the assigned untreated water branch connection 6 when the valve 7 is open. The supplied quantity of untreated water is adjusted by means of the regulating valve 15. In the preferred embodiment, the regulating valve is adjusted in such a way that a quantity of 35 m3/h passes through in normal operation.

The untreated water reaches each module 2 via the sub-branch connections 6 and penetrates through the walls of the hollow fibers. The filtered water that has passed through leaves the modules 2 via the filtrate lines 12 and the open valves 13 and reaches the filtrate collection line 14, which collects the accumulated filtrate from all groups 2A to 2F; this accumulated filtrate is then discharged via the regulating valve 15 and the discharge line 16. The valves 9 are closed during the filtration process.

While one group is being cleaned, the valve 7 assigned to this group is closed and the valve 9 is opened. The intake pump is brought to an increased flow level, which, as an unregulated workpoint, adapts corresponding to the pump's characteristic curve by means of a bypass to the current non-filtering group being switched with the help of the regulating valve 15 and via the assigned opened valve 13. The excess filtrate forced back by the regulating valve 15 arrives in each module 2 that is currently to be rinsed via the filtrate branch connection 12 in the direction of flow opposite to the direction of flow during filtering and removes the substances stuck on the untreated water side of the hollow fiber wall and rinses these into the wastewater collection line 10 first via the portion of the untreated water branch connection 6 and, because the valve 7 is closed and the valve 9 has been opened, via the wastewater disposal branch connection 8, whereby the quantity flowing out is regulated by means of the regulating valve 11. On the other side of the regulating valve 11, the wastewater with the impurities that have been rinsed off reaches a conduit 18 or another device for disposal or further utilisation of the wastewater.

During this backwashing, the other stages continue to filter, so that there is no reduction in the quantity of filtrate due to the increased inflow of untreated water.

In the preferred embodiment, a quantity of roughly 24 m³/h per group is supplied for rinsing, so that in order to maintain the adjusted quantity of 35 m³/h, 59 m³/h of filtrate must be generated by the remaining five groups.

For CIP, in the case of the filtration system 1 according to the disclosure, a cleaning line 19 (CIP supply line), which originates in a customary mixing tank and in which chemicals are added to the cleaning liquid, discharges into the untreated water line 3, to wit, before the pre-filter/pump complex 4. The cleaning tank can likewise be supplied with filtrate as a cleaning liquid. Then the cleaning liquid reaches the individual modules 2 of all groups 2A to 2F via the untreated water line 3 with valves 7 opened and valves 9 closed, and leaves the modules as a cleaned filtrate via the filtrate branch connections 12 and filtrate collection line 14. A double-seated valve 20 prevents chemicals from the CIP from reaching the filtrate. The cleaning fluid reaches the CIP return line via 21.

As an additional possibility, a second untreated water/wastewater complex is provided in each group, whereby this complex contains a line 60, comparable to the untreated water branch connection 6, with the cut-off valve 70, which however, unlike the untreated water branch connection 6, leads into the upper area of the modules 2, i.e., into the filtrate area. The wastewater disposal line 80 with the valve 90 is also provided in the second branch, whereby this wastewater disposal line 80 discharges into the wastewater collection line. This second branch is normally shut down, but can be enlisted as support for CIP.

1. Method for filtering water comprising utilizing a plurality of individual filtration modules, each of which is supplied from an untreated water supply via at least one untreated water inlet and from which filtrate is removed via a filtrate outlet, cleaning the filtration modules by backwashing with a filtrate, dividing the filtration modules into a plurality of groups, and during backwashing, separating each group from the untreated water supply individually and rinsing with the filtrate that is produced by the rest of the groups and feeding back during the backwashing.

2. Method according to claim 1, and during the backwashing of one group, increasing the filtrate quantity generated by the other groups.

3. Method according to claim 1, and regulating the quantity of the outwardly flowing filtrate downstream of all groups.

4. Method according to claim 1, and regulating the quantity of backwashing liquid.

5. Method according to claim 1, and wherein cleaning-in-place takes place from the untreated water side.

6. Filtration system, particularly an ultrafiltration system, comprising a plurality of individual filtration modules, each with at least one untreated water inlet connected to an untreated water line and one filtrate outlet connected to a filtrate collection line, a backwashing device for backwashing with filtrate, the filtration modules being divided into groups, wherein each group can be separated from the untreated water line independently of the other groups.

7. Filtration system according to claim 6, wherein the filtrate collection line has a cut-off device downstream of all groups.

8. Filtration system according to claims 6, and a wastewater disposal line is connected to all modules, and a regulating valve is arranged in the wastewater disposal line for regulating the quantity of wastewater during backwashing.

9. Filtration system according to claim 6, and a controllable intake pump is provided in the untreated water intake.

10. Filtration system according to claim 6, and a cleaning-in-place line leads into the untreated water line.

11. Filtration system according to claim 7, wherein the cut-off device is a regulating device.

12. Filtration system according to claim 10, wherein the cleaning-in-place line is upstream of a pre-filter/pump complex.
